(19) United States
(12) Patent Application Publication
(10) Pub. No.: US 2015/0116778 A1
(43) Pub. Date: Apr. 30, 2015

(54) INFORMATION PROCESSING APPARATUS AND STORAGE MEDIUM

(71) Applicant: CANON KABUSHIKI KAISHA, Tokyo (JP)

(72) Inventor: Tsuyoshi Itami, Kawasaki-shi (JP)

(21) Appl. No.: 14/520,130

(22) Filed: Oct. 21, 2014

(30) Foreign Application Priority Data
Oct. 25, 2013 (JP) 2013-222523

(51) Int. Cl. G06K 15/02

(52) U.S. Cl. CPC G06K 15/1823; G06K 15/1813; G06K 15/1815; G06K 15/1851; G06K 15/1886; G06K 15/1878; G06K 15/1881; H04N 2201/0094
USPC 358/2.1; 358/1.16; 358/1.13

(57) ABSTRACT

The information processing apparatus according to the present invention is configured to generate second print data without dividing image data into units of bands if it is determined that memory of the information processing apparatus for generating the second print data has been successfully allocated, and to generate first print data by dividing image data into units of bands if it is determined that the memory of the information processing apparatus for generating the second print data has failed to be allocated.

### BACKGROUND

1. Field of the Disclosure

Aspects of the present invention generally relate to a technique for transmitting print data.

2. Description of the Related Art

Japanese Patent Application Laid-Open No. 2002-207580 discusses a technique for converting print data output by a printer driver from an application program into page description language (PDL) data that can be interpreted by a printer, and transferring the converted data to the printer via a printer cable.

Japanese Patent Application Laid-Open No. 2002-207580 does not discuss the fact that there is a plurality of types of page description language data (hereinafter referred to as “print data”) that can be interpreted by one printer. If a print processing apparatus including a printer can provide various printing methods, an improvement in user convenience can be achieved. Therefore, in this specification, consideration is given to a case in which, depending on the print processing apparatus, there is a plurality of types of print data that can be supported thereby.

In this case, the user's printing environment may mix print processing apparatuses that support one type of print data and print processing apparatuses that support a plurality of types of print data.

In addition, the following problems can also occur. For example, even if the print processing apparatus that performs printing supports printing of first print data and second print data, the amount of memory used during print data generation and the processing time taken for print data generation may differ depending on the type of print data. For example, if the amount of memory used during print data generation is greater for the second print data than the first print data, but the processing time taken for print data generation is faster for the second print data than the first print data, from the perspective of high-speed printing, it is better to perform printing using the second print data. However, since the amount of memory used during print data generation is greater for the second print data, the print processing apparatus may become unstable or the application may be forcibly shut down.

### SUMMARY

Aspects of the present invention are relate to realizing printing according to a printing environment including a memory status by considering whether a print processing apparatus supports processing of second print data and whether memory for generating the second print data has been successfully allocated.

According to an aspect of the present invention, an information processing apparatus includes a generation unit configured to generate first print data by dividing image data into units of bands or second print data without dividing image data into units of bands, and a determination unit configured to determine whether memory of the information processing apparatus for generating the second print data has been successfully allocated, in which the generation unit is configured to generate the second print data if the determination unit determines that the memory of the information processing apparatus for generating the second print data has been successfully allocated, and to generate the first print data if the determination unit determines that the memory of the information processing apparatus for generating the second print data has failed to be allocated.

Further features of the present invention will become apparent from the following description of exemplary embodiments with reference to the attached drawings.

### BRIEF DESCRIPTION OF THE DRAWINGS

FIG. 1 illustrates a configuration of a data processing apparatus.

FIG. 2 illustrates a hardware configuration of a data processing apparatus.

FIG. 3 is a block diagram illustrating a hardware configuration in a print processing apparatus.

FIG. 4 is a block diagram illustrating a software configuration of a data processing apparatus.

FIG. 5 illustrates an example of a user interface (UI) that can be displayed by a data processing apparatus.

FIG. 6 illustrates an example of a UI that can be displayed by a data processing apparatus.

FIG. 7 is a flowchart illustrating a processing flow of a data processing apparatus.

FIG. 8 is a chart illustrating a processing order, a memory usage amount characteristic, and a processing load characteristic based on PDL type.

FIG. 9 illustrates an example of a UI that can be displayed by a data processing apparatus.

FIG. 10 illustrates an example of a UI that can be displayed by a data processing apparatus.

FIG. 11 is a flowchart illustrating a processing flow of a data processing apparatus.

FIG. 12 illustrates an example of a UI that can be displayed by a data processing apparatus.

FIG. 13 illustrates an example of a UI that can be displayed by a data processing apparatus.

FIG. 14 illustrates a generation order of each PDL.

### DESCRIPTION OF THE EMBODIMENTS

Various exemplary embodiments, features, and aspects of the invention will be described in detail below with reference to the drawings.

An exemplary embodiment will be described using an example of a printing program that prints, on a print processing apparatus, document data stored in a mobile device such as a smartphone as an example of an information processing apparatus. The printing program executes print processing by converting document data selected by a user into PDL data, which is print data, and transmitting the converted PDL data to the print processing apparatus.

Next, a print processing apparatus will be described. In one of the printing environments envisaged in the specification, the types of PDL that can be processed by a print processing apparatus might be limited depending on the print processing apparatus. For example, since a print processing apparatus aimed at low-end users has a simply configured processing apparatus on the print processing apparatus side, the PDLs supported by the print processing apparatus need to be configured from printer-resolution raster image data that has been halftone-processed based on toner colors. In the case of such a PDL (hereinafter referred to as “toner array-based PDL”), the print processing apparatus can directly use the PDL data as array data to apply toner, which enables the processing apparatus on the print processing apparatus side to be simplified.

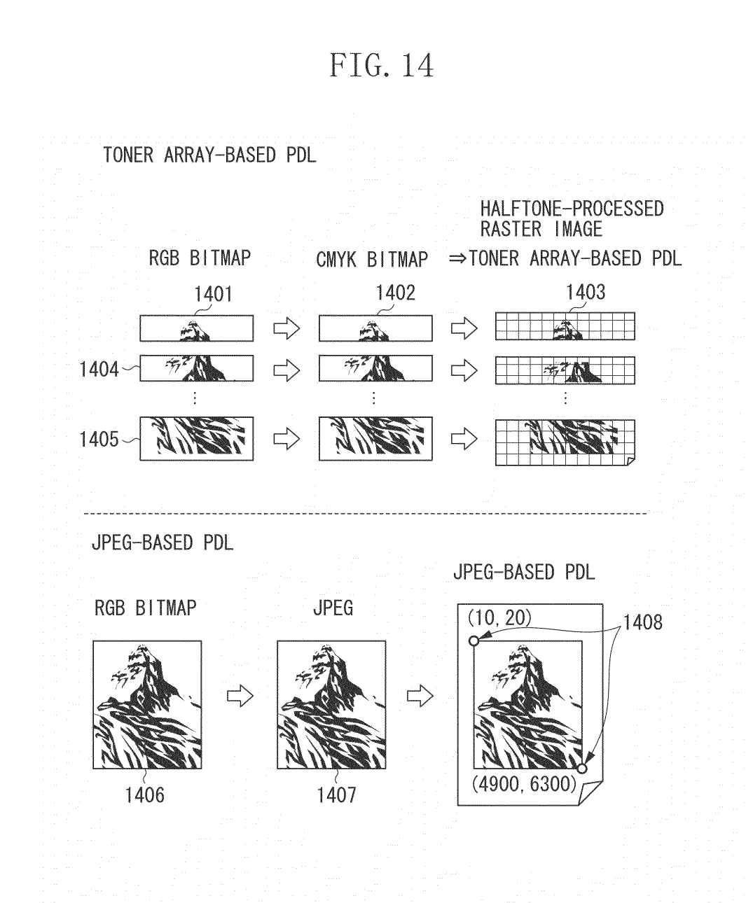

Further, by executing print processing with a toner array-based PDL, the host side that issues a print instruction to the print processing apparatus can also be configured as follows. Since a toner array-based PDL is not converted into lossy compression format data, a certain portion on an original page can be partially rendered (a red, green, and blue (RGB) bitmap can be partially generated) as indicated by a portion 1401 illustrated in FIG. 14. Further, the rendered portion is converted into data of toner colors (cyan, magenta, yellow, and black (CMYK) colors) (a CMYK bitmap is generated) as indicated by a portion 1402 illustrated in FIG. 14, converted into halftone-processed raster image data as indicated by a portion 1403 illustrated in FIG. 14, and then transmitted to the print processing apparatus. If an RGB bitmap is, for example, several thousand dots, since the bitmap is processed in band units of several tens of dots, the color conversion from the RGB bitmap into a CMYK bitmap and the halftone processing are repeated until the entire page has been supplemented (in addition to the portion 1401, these processes are also executed on portions 1404 and 1405, which have not yet been rendered). Consequently, the original page can be converted into one page's worth of print data.

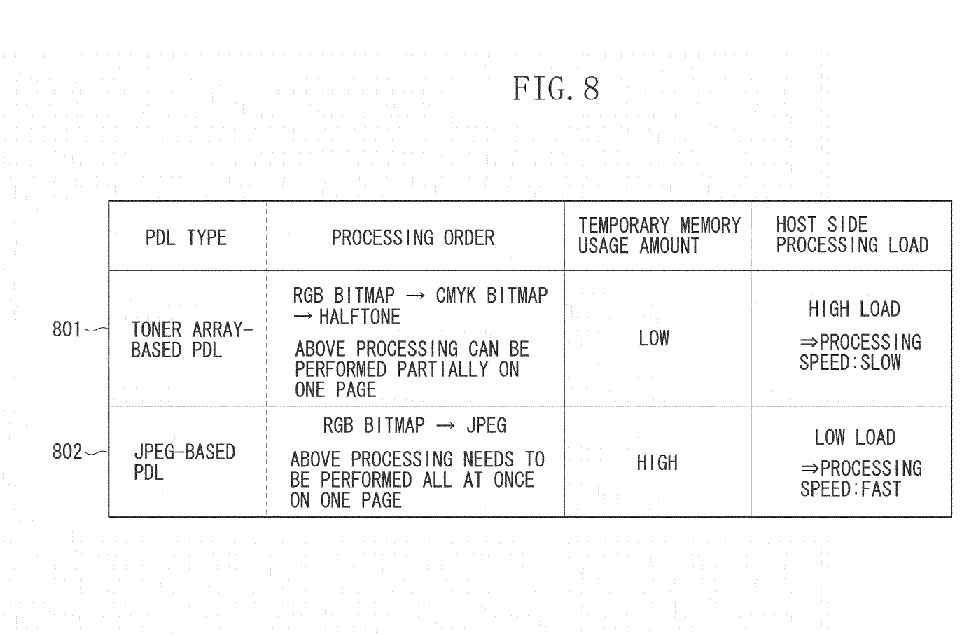

Since a toner array-based PDL allows a page to be partially processed, the host side and the print processing apparatus can be operated even if the memory amount that is temporarily used is small. However, the host side needs to generate printer-resolution raster image data that has been halftone-processed based on the toner colors, across the entire page. As a result, the processing amount itself for generating the PDL becomes very large. Characteristics of a toner array-based PDL are illustrated as a chart in a row 801 of FIG. 8.

On the other hand, to handle a variety of user needs, in this specification, consideration is given to supporting PDLs other than a toner array-based PDL. It is assumed here that a print processing apparatus that supports a plurality of PDLs executes print processing by selecting an appropriate PDL based on the type of PDL that has been received. The print processing apparatus may have, for example, a function capable of printing, as a non-toner array-based PDL, a Joint Photographic Experts Group (JPEG) image that is on a universal serial bus (USB) memory which has been inserted into the print processing apparatus. Incorporating such a function in a print processing apparatus can realize a print processing apparatus that supports a PDL based on JPEG (hereinafter referred to as “JPEG-based PDL”) even for print data transmitted from an information processing apparatus. Further, although a description is given using JPEG as an example in the specification, other formats such as portable network graphics (PNG) and tagged image file format (TIFF) may also be supported.

However, when generating a JPEG-based PDL, one page's worth of print data needs to be generated by forming a JPEG image for one page as one image. This is because, as described above, the basis of the print processing is that, for one JPEG file stored in the USB memory, the function on the print processing apparatus side prints that one JPEG file on one page.

Due to the above-described restriction when generating a JPEG-based PDL, the processing on the host side needs to be performed as follows. The entire page of the original is first rendered, a raster image representing one entire page as indicated by an image 1406 illustrated in FIG. 14 (a bitmap representing one entire page) is generated, and based on the raster image, the data is converted into a JPEG image as indicated by an image 1407 illustrated in FIG. 14. The above raster image has a resolution that is sufficient to ensure print quality (e.g., an A4 size, 600 dpi raster image). Since the raster image needs to be loaded into the memory for JPEG conversion, although temporarily, a large amount of memory is used. However, if the processing can proceed this far, as indicated by an image 1408 illustrated in FIG. 14, a JPEG-based PDL can be generated simply by placing the JPEG on an arbitrary position on the page. Characteristics of a JPEG-based PDL are illustrated as a chart in a row 802 of FIG. 8.

Therefore, in a mobile operating system (OS) environment that has severe restrictions on high memory usage, for example, an application that executes JPEG-based PDL generation processing has the risk of being forcibly shut down by the OS.

Hereinafter, an example of such a printing environment that mixes print processing apparatuses supporting a toner array-based PDL and print processing apparatuses supporting both a toner array-based PDL and a JPEG-based PDL will be described.

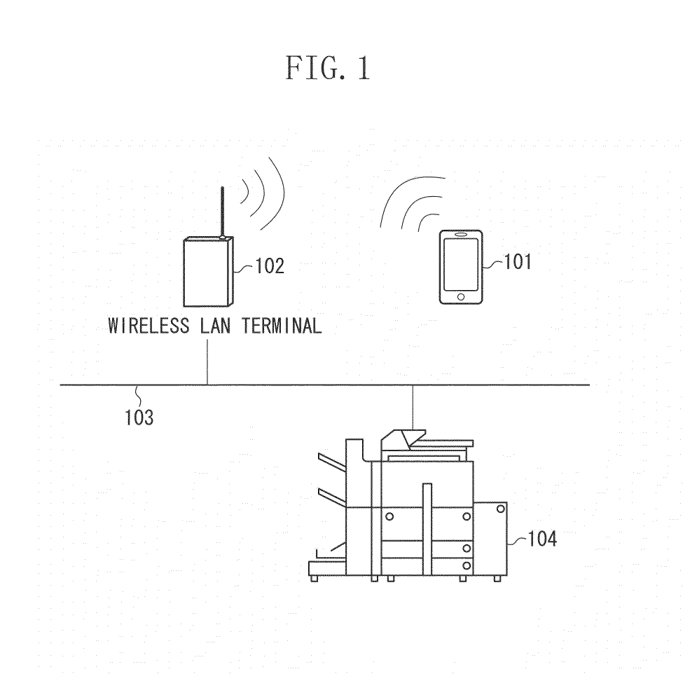

A first exemplary embodiment will now be described. FIG. 1 illustrates a configuration of a data processing system according to a first exemplary embodiment of the present invention. This example illustrates a system in which a mobile type data processing apparatus and a print processing apparatus can communicate with each other via a network. The data processing apparatus is an example of an information processing apparatus.

In FIG. 1, a mobile type data processing apparatus 101 is a computer that is used by a user to issue a print data transmission instruction to a print processing apparatus 104. The print processing apparatus 104 includes, in addition to a printer function, a copy function, a scanner function, a facsimile (FAX) sending function and the like.

The data processing apparatus 101 and the print processing apparatus 104 exchange information with each other via a local area network (LAN) 103 that the apparatuses are connected to. A wireless LAN terminal 102 is a wireless LAN base unit that has a general network router function, which provides a wireless LAN in locations such as in the home and in offices. Further, since the data processing apparatus 101 is a mobile terminal, the data processing apparatus 101 can join the LAN 103 via the wireless LAN terminal 102. When the data processing apparatus 101 enters a wireless LAN area provided by the wireless LAN terminal 102, the data processing apparatus 101 can automatically join the LAN 103 network by utilizing pre-set authentication information.

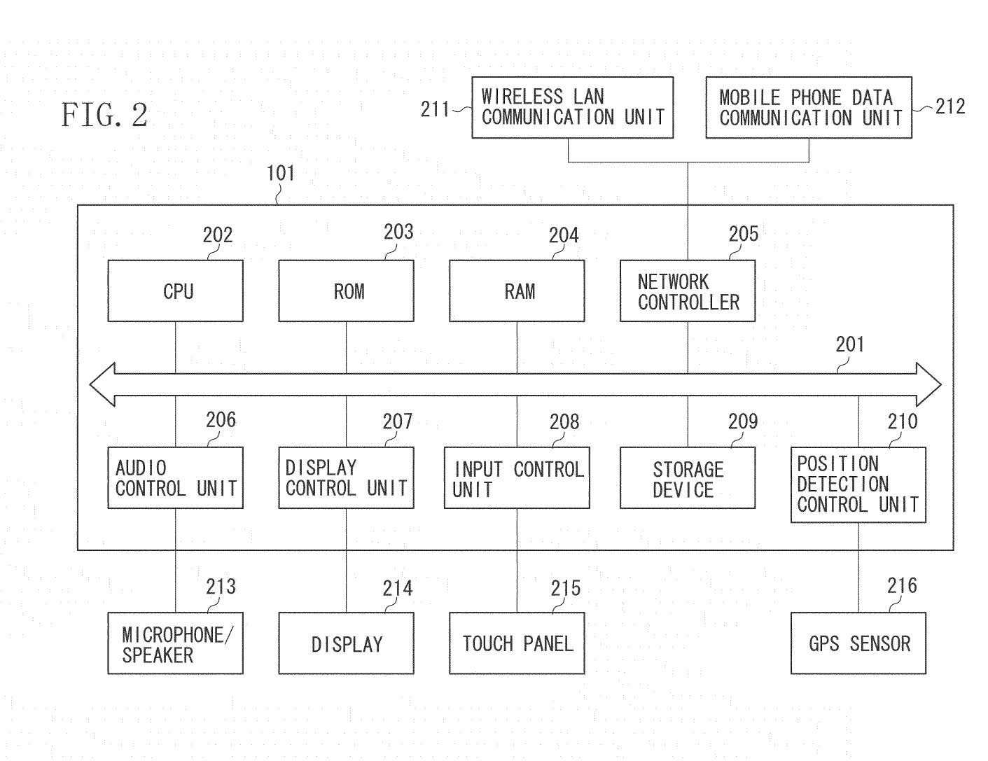

FIG. 2 is a block diagram illustrating a hardware configuration of the data processing apparatus 101 illustrated in FIG. 1.

The data processing apparatus 101 is a mobile terminal or a smartphone on which an operating system for compact terminals, and programs for controlling telephone calls and data communication may be running. Alternatively, the data processing apparatus 101 may be a personal computer that does not have an audio control unit 206, a microphone/speaker 213, a position detection control unit 210, a global positioning system (GPS) sensor 216, and a mobile phone data communication unit 212 (which will be described below).

Each component of the hardware is connected to a system bus 201. A read-only memory (ROM) 203 stores the operating system of the data processing apparatus 101, and applications for controlling telephone calls and data communication, which are executed by a central processing unit (CPU) 202. Examples of applications for controlling data communication include a print application, Email software, and a Web browser.

A random-access memory (RAM) 204 is a work memory area for executing programs. The RAM 204 is a work memory area in which a print application generates print data. Further, the RAM 204 is also a memory for temporarily storing Web page data acquired by the Web browser from a Web server or authentication information for accessing a Web service. A storage device 209 is a non-volatile storage device that stores various operation mode settings that need to be stored even after the data processing apparatus 101 is restarted, an operating log and the like.

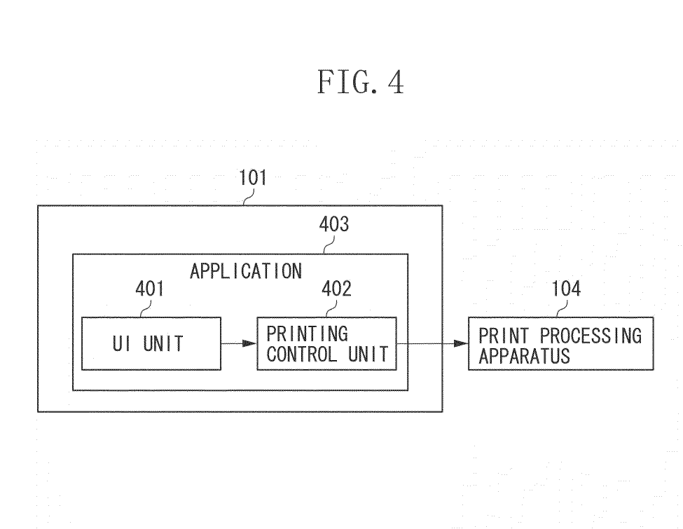

In addition, the software configuration of the data processing apparatus 101 as illustrated in FIG. 4 and the processing of the respective steps in the below-described flowcharts are executed by the CPU 202 executing processing based on programs stored in the storage device 209.

A network controller 205 performs communication control of a wireless LAN communication unit 211 for joining the LAN 103 network via the wireless LAN terminal 102, and communication control of the mobile phone data communication unit 212 for joining a network provided by a mobile carrier. Generally, when a wireless LAN network can be joined, the network controller 205 gives priority to the wireless LAN connection. When the data processing apparatus 101 moves outside the wireless LAN network area, the data processing apparatus 101 joins a wireless communication network provided by a mobile carrier.

The audio control unit 206 is mainly utilized when a user makes a telephone call by starting a telephone call application. Input and output of audio data is performed by the microphone/speaker 213. The audio control unit 206 acts as an intermediary with a control program of the microphone/speaker 213.

A display control unit 207 controls the information that is output to a display 214 of the data processing apparatus 101. An input control unit 208 controls the information of an instruction issued by the user using a button or a touch panel 215 on the data processing apparatus 101. Utilizing the audio control unit 206, the display control unit 207, and the input control unit 208, applications on the data processing apparatus 101 provide the user with network communication information and various information of the data processing apparatus 101.

The position detection control unit 210 acquires positional information about the data processing apparatus 101 from the GPS sensor 216, and provides the information to the operating system. The above control is performed by the operating system run by the CPU 202.

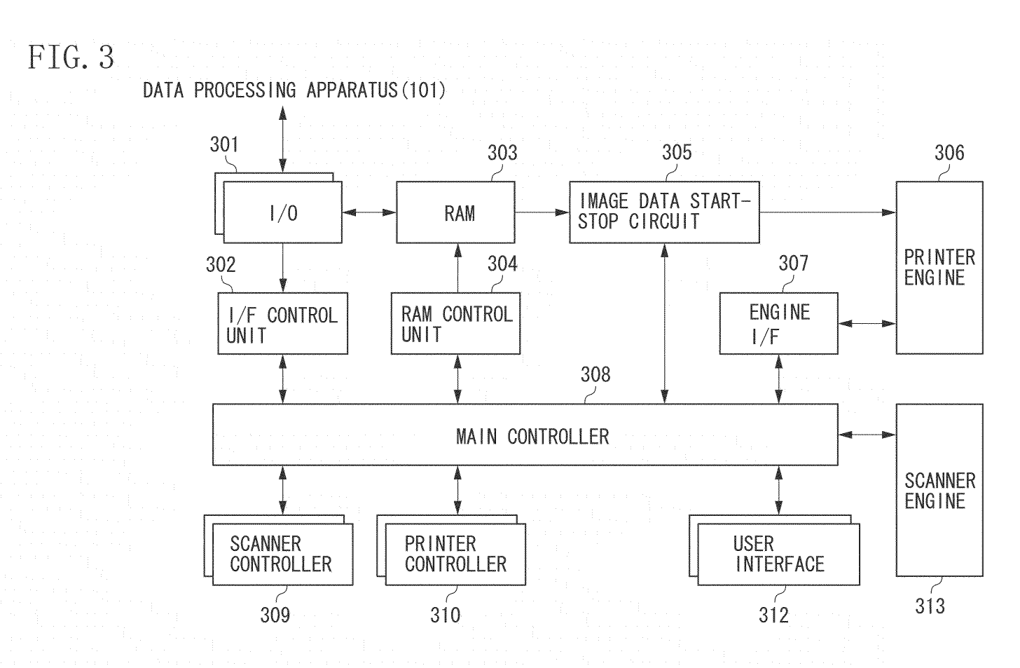

FIG. 3 is a block diagram illustrating a hardware configuration in the print processing apparatus 104 illustrated in FIG. 1. FIG. 3 illustrates an example of a multifunction peripheral (MFP) that has a scanner function and a printer function.

In FIG. 3, an input/output (I/O) 301 is connected to the data processing apparatus 101 via a communication medium such as the network (LAN) 103. A plurality of I/Os 301 may be mounted in order to handle a plurality of connection modes.

The print processing apparatus 104 transfers a device ID and a scanned image to the data processing apparatus 101 via the I/O 301. Further, various control commands are received and processed by the data processing apparatus 101.

An interface (I/F) control unit 302 controls the issuing of a device ID relating to a processing system such as the scanner and the printer mounted in the print processing apparatus 104. A RAM 303 is a primary storage device that is used to store external data such as a control command acquired by the I/O 301, and images read by a scanner engine 313. Further, the RAM 303 is used to store images rasterized by a printer controller 310 before they are transferred to a printer engine 306.

The assignment management of the RAM 303 is performed by a RAM control unit 304. An image data start-stop circuit 305 is a device for outputting an image input by the printer controller 310 or the scanner engine 313 and rasterized by the RAM control unit 304, in time with the rotation of the printer engine 306.

The printer engine 306 is a device which develops an image on an output medium such as paper. A main controller 308 performs various control of the printer engine 306 via an engine I/F 307.

Further, the main controller 308 is a core control module that appropriately distributes control languages received from the data processing apparatus 101 via the I/O 301 to a scanner controller 309 and the printer controller 310. In addition, the main controller 308 controls the printer engine 306 and the scanner engine 313 by receiving instructions from the respective controllers and a user interface 312.

An expansion board capable of processing a plurality of types of control commands in one peripheral device can be mounted by unifying the control interface between the main controller 308 and the various controllers. Further, the main controller 308 also has a role of acquiring and managing the device IDs of the currently mounted expansion controllers from each of the controllers.

The scanner controller 309 breaks down a scan control command received from the data processing apparatus 101 into internal execution commands that can be interpreted by the main controller 308. Further, the scanner controller 309 changes an image read by the scanner engine 313 into a scan control command.

The printer controller 310 breaks down a PDL received from the data processing apparatus 101 as print data into internal execution commands including a rasterized image that can be interpreted by the main controller 308. The rasterized image is conveyed to the printer engine 306, and printed on an output medium such as paper. Further, in terms of the fact that a toner array-based PDL is printer-resolution raster image data that has been halftone-processed based on the toner colors, a toner array-based PDL is equivalent to the rasterized image to be conveyed to the printer engine. Therefore, for a print processing apparatus that is based on the assumption of only supporting a toner array-based PDL, since the processing related to the above can be omitted, the configuration of the print processing apparatus 104 can be simplified.

FIG. 4 is a block diagram illustrating a software configuration of the data processing apparatus 101 illustrated in FIG. 1. A printing control unit 402 is installed as an application in the ROM 203. The printing control unit 402 has a function of generating print data and transmitting the generated print data to the print processing apparatus 104 which the printing control unit 402 can communicate with. An application 403, which includes various user interfaces for executing the above functions, manages the execution of each functional process in response to receiving a request from the user on the user interface of the data processing apparatus 101.

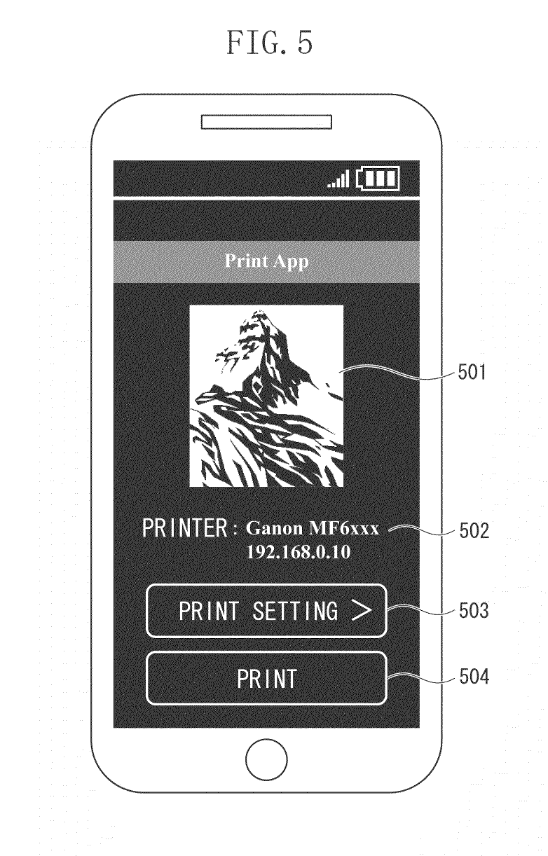

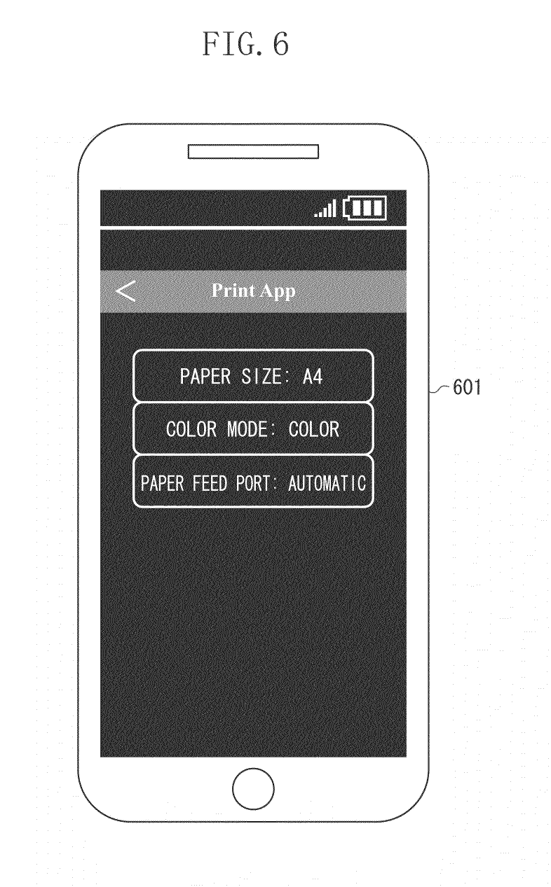

FIG. 5 illustrates an example of a user interface to be used by the data processing apparatus 101 to process reception of various input operations from the user. A preview 501 of the original data to be printed is displayed on the user interface. An area 502 indicates a printer model name of the print processing apparatus 104 that performs printing, and an internet protocol (IP) address of the print processing apparatus 104. The user interface also includes a button 503 for transitioning to a screen for selecting print settings. Pressing the button 503 causes a transition to a print setting screen illustrated in FIG. 6, which allows various print settings to be selected. A button 504 acts as a trigger to start print processing. An operation will now be described in which the button 504 is pressed and the type of print data to be transmitted to the print processing apparatus 104 is determined.

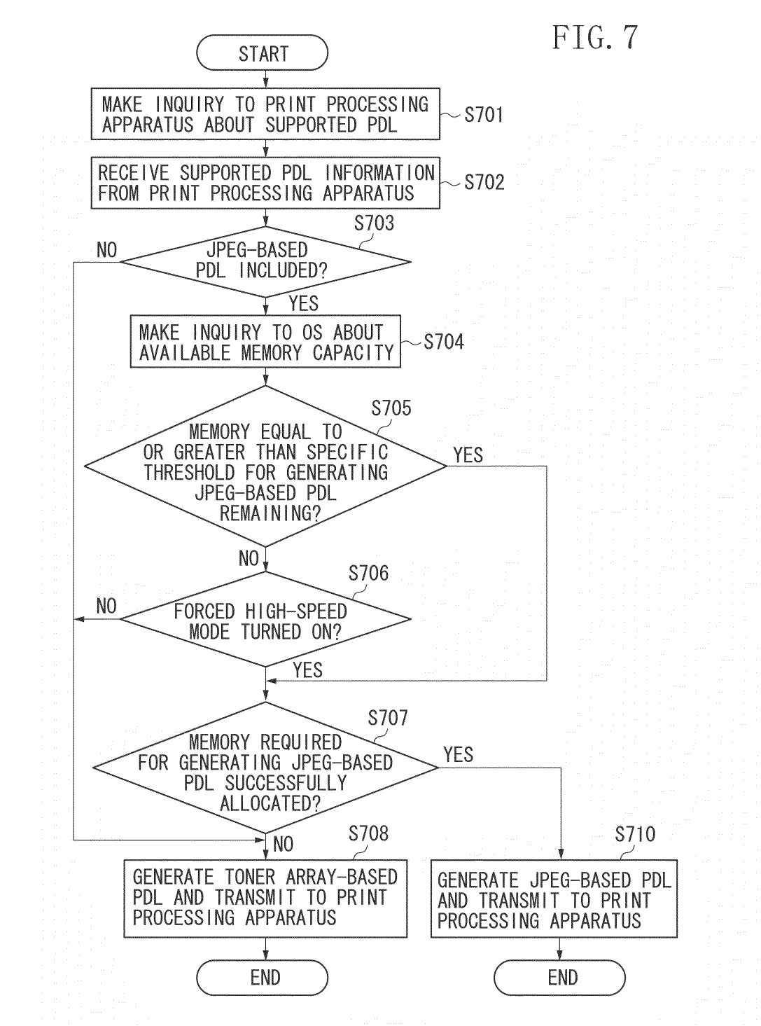

FIG. 7 is a flowchart illustrating print data type determination processing by the data processing apparatus 101. This processing is based on the assumption that the trigger for starting the flowchart is an operation in which the file serving as the original for printing (e.g., the image data corresponding to the preview 501) has been input, and the screen illustrated in FIG. 5 is in a displayed state.

In step S701, the data processing apparatus 101 makes an inquiry to the print processing apparatus 104 about the PDLs that can be processed by the print processing apparatus 104. Information relating to the PDLs that can be processed by the print processing apparatus 104 is acquired based on management information base (MIB) information of the print processing apparatus 104. The MIB refers to information that a network device (in the present exemplary embodiment, the print processing apparatus 104) managed based on a simple network management protocol (SNMP) has made publicly available to inform other devices of the state of that network device. This MIB is defined by Request for Comments (RFC) 1213. The MIB for inquiring about the PDLs that can be processed by the print processing apparatus 104 uses “prtInterpreterDescription”.

In step S702, the data processing apparatus 101 analyzes the MIB received from the print processing apparatus 104, and acquires the types of PDL supported by the print processing apparatus 104. Acquisition of the types of PDL supported by the print processing apparatus 104 can be performed by acquiring all the types of PDL that are supported by dividing the communication into a plurality of times, or by acquiring all the types of PDL that are supported in one communication. Alternatively, the data processing apparatus 101 may make an inquiry about whether a specific type of PDL (e.g., a JPEG-based PDL) is supported, and the print processing apparatus 104 can respond that it does support the specific type of PDL for which an inquiry has been made.

In step S703, the data processing apparatus 101 analyzes the PDL types acquired in step S702, and determines whether a JPEG-based PDL is included in the PDLs supported by the print processing apparatus 104. If a JPEG-based PDL is included in the PDLs supported by the print processing apparatus 104 (YES in step S703), the processing proceeds to step S704. If a JPEG-based PDL is not included in the PDLs supported by the print processing apparatus 104 (NO in step S703), the processing proceeds to step S708.

In step S704, the data processing apparatus 101 makes an inquiry to the OS about the currently available memory capacity. If using a virtual memory, the currently available memory capacity is determined by adding the free capacity of the storage device 209 to the free capacity of the RAM 204. For example, for an application running on the Android OS, memory-related information can be acquired by using the “Activity Manager”, which is a function provided by the OS.

In step S705, the data processing apparatus 101 determines whether the free capacity remaining in the memory is equal to or greater than a specific threshold value for generating a JPEG-based PDL.

When generating a JPEG image, the data format serving as the source needs to be an RGB-color uncompressed image (corresponding to an RGB bitmap). To rasterize that data, the remaining memory capacity needs to be of a specific size. For example, when rasterizing RGB bitmap data at 300 dpi (2480 px×3508 px) for one A4 size (210 mm×297 mm) page on the memory, 24-bit color data for 8,699,840 pixels is required, so that a total of about 26 MB of remaining memory capacity is needed.

The determination processing in step S705 is performed for the purpose of avoiding a forced shutdown from the OS. Therefore, for the above-described required remaining memory capacity (about 26 MB), the specific threshold value is set at twice or more the remaining memory capacity (about 52 MB), for example. In this determination processing, if it is determined that the remaining memory capacity is equal to or greater than the specific threshold value (YES in step S705), the processing proceeds to step S707. On the other hand, if the remaining memory capacity is less than the specific threshold value (NO in step S705), the processing proceeds to step S706.

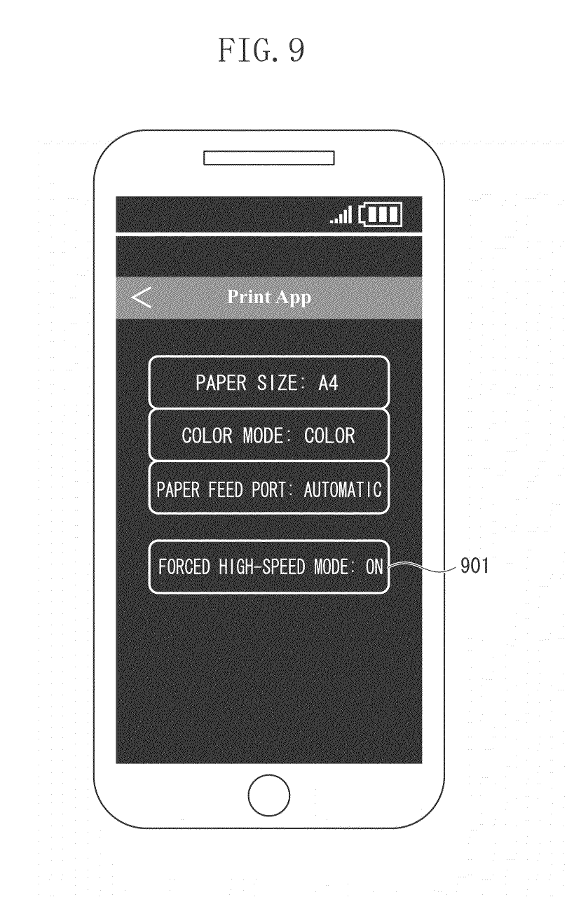

In step S706, the data processing apparatus 101 determines whether a forced high-speed mode, which is an example of a processing mode, is enabled or disabled. The forced high-speed mode is, as indicated by an area 901 illustrated in FIG. 9, provided as a print setting that is selectable by the user. If the forced high-speed mode is enabled (YES in step S706), the processing proceeds to step S707, and the data processing apparatus 101 tries to allocate sufficient memory for generating a JPEG-based PDL. If the forced high-speed mode is disabled (NO in step S706), the processing proceeds to step S708.

In step S707, the data processing apparatus 101 determines whether the memory required for generating a JPEG-based PDL has been successfully allocated. Based on the same assumption as above, an A4 size (210 mm×297 mm) at 300 dpi, the data processing apparatus 101 determines whether 26 MG of memory has been successfully allocated. In this step, if the memory has been successfully allocated (YES in step S707), the processing proceeds to step S710. On the other hand, if the memory has failed to be allocated (NO in step S707), the processing proceeds to step S708. Examples of failure to allocate the memory include a case in which although there was free memory at step S705, the memory is not free when actually allocating the memory in step S707, or a case in which the allocation of memory in the forced high-speed mode has failed.

In step S710, the data processing apparatus 101 generates a JPEG-based PDL, and transmits the generated PDL as print data to the print processing apparatus 104.

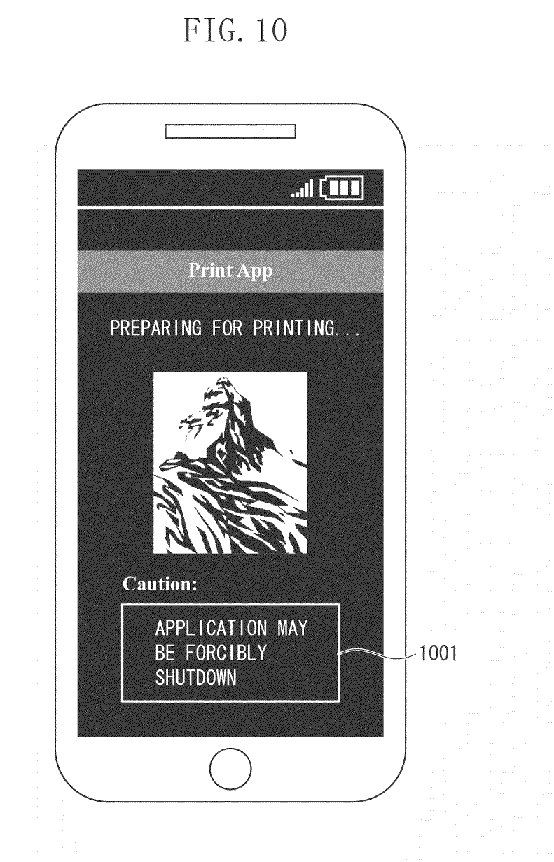

If the forced high-speed mode is enabled and the processing has proceeded to step S707, and in step S707 the memory has successfully been allocated (YES in step S707), the processing flow may also be configured so that before proceeding to step S710, a warning is issued to the user. This is because even if the memory has successfully been allocated in step S707, in the preceding step S705 it has been determined that the remaining memory capacity is less than the specific threshold value, so that it is highly likely that the OS running on the data processing apparatus 101 does not have much memory left. Therefore, even if the memory has been successfully allocated, the print application may be forcibly shut down during processing. In view of this, when the processing proceeds from step S706 to step S707, and the memory has been successfully allocated in step S707 (YES in step S707), a reminder message as indicated by an area 1001 illustrated in FIG. 10 may be displayed before proceeding to step S710. Further, this reminder message may be a message prompting the user to close other applications.

In step S708, the data processing apparatus 101 generates a toner array-based PDL, and transmits the generated PDL as print data to the print processing apparatus 104. As described above, the generation processing of a toner array-based PDL requires less memory capacity (see the row 801 in FIG. 8). Further, as described above, a toner array-based PDL is equivalent to a rasterized image that can be directly interpreted by a printer engine. Therefore, using a toner array-based PDL has the advantage that the printing can be performed even for a low-function print processing apparatus, and the advantage that the load on a print processing apparatus is less.

Through the above processing according to the present exemplary embodiment, a data processing apparatus automatically selects an appropriate PDL according to the status of the resource (remaining memory capacity) of the OS. Therefore, the user does not need to manually change the PDL according to the status, and can avoid a forced shutdown of an application from the OS which is caused by errors in human judgment. Further, even when high-speed processing, which uses a lot of memory, is forcibly performed, by employing a configuration in which a reminder message is displayed, the user can be prompted to shut down applications other than those of the print processing apparatus.

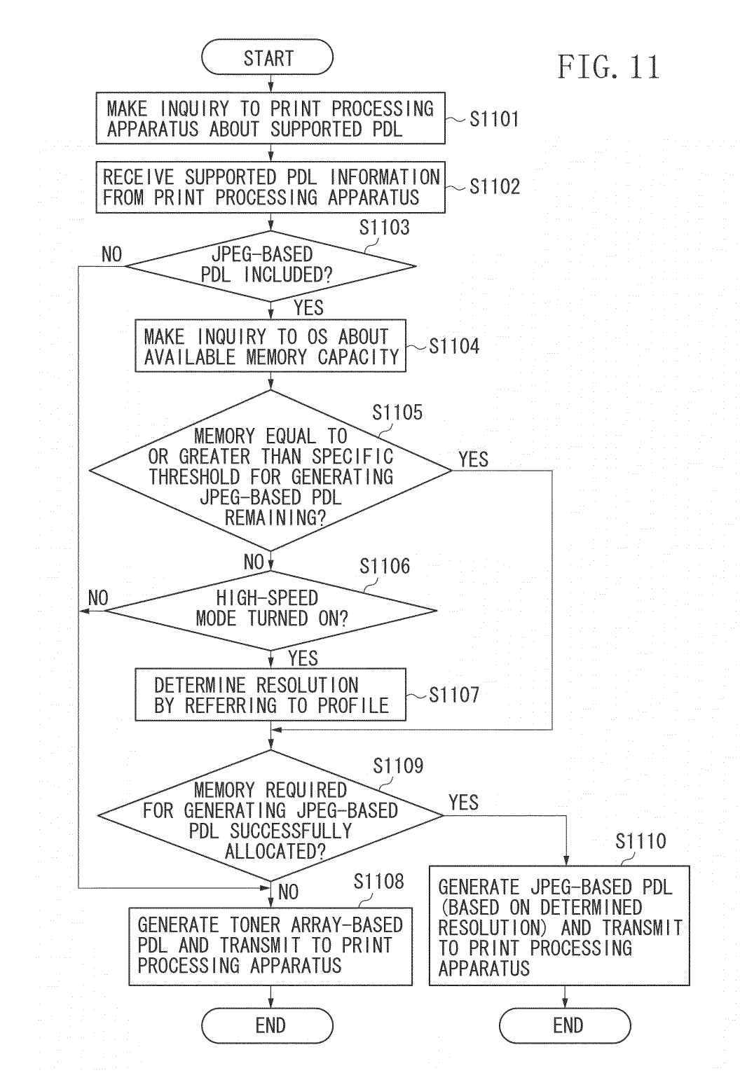

A second exemplary embodiment will now be described. In the present exemplary embodiment, processing will be described in which the resolution of a JPEG image to be generated is changed according to the available remaining memory capacity. The processing according to the second exemplary embodiment will be described below with reference to the flowchart of FIG. 11.

Since steps S1101, S1102, S1103, S1104, and S1105 in the second exemplary embodiment are similar to steps S701, S702, S703, S704, and S705 in the first exemplary embodiment, in the second exemplary embodiment, the processing from step S1106 onwards will be described in more detail.

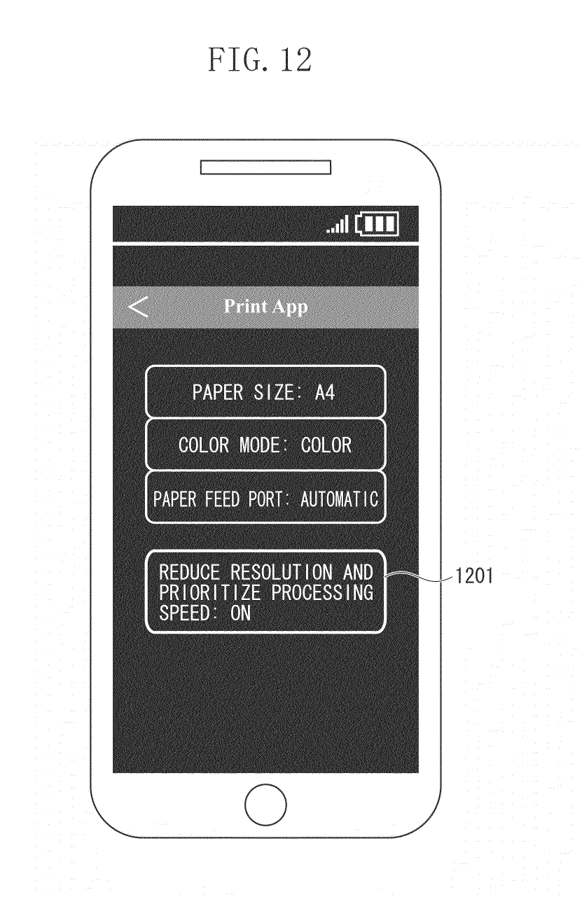

In step S1106, the data processing apparatus 101 determines whether a mode that speeds up processing (high-speed mode), which is an example of a processing mode, by reducing the resolution to generate a JPEG-based PDL is enabled or disabled. The high-speed mode is, as indicated by an area 1201 illustrated in FIG. 12, provided as a print setting that is selectable by the user. If the high-speed mode is enabled (YES in step S1106), the processing proceeds to step S1107. If the high-speed mode is disabled (NO in step S1106), the processing proceeds to step S1108.

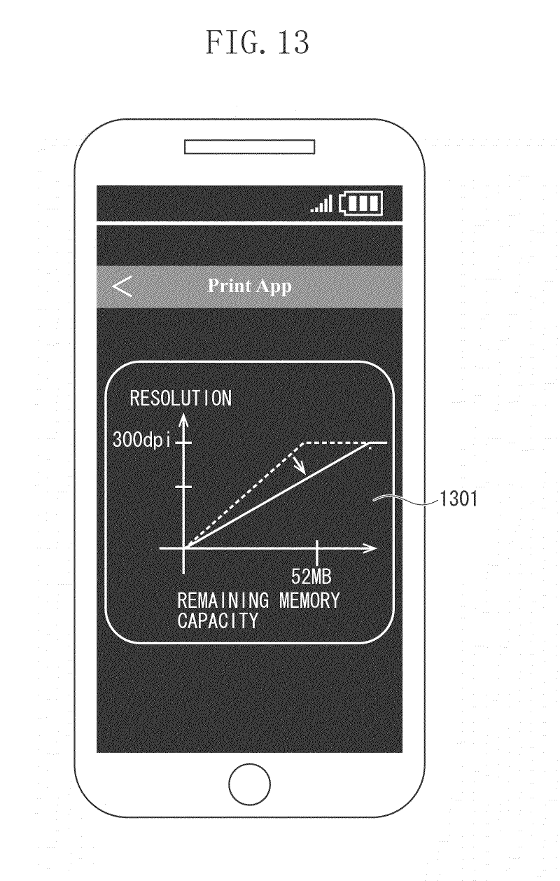

In step S1107, the data processing apparatus 101 determines the resolution of the JPEG image to be generated, by referring to the profile that defines, based on the currently available remaining memory capacity, the resolution of the JPEG image to be generated. More specifically, for example, if the currently available remaining memory capacity is 26 MB, the resolution is determined to be 150 dpi. As indicated by an area 1301 illustrated in FIG. 13, the profile may be provided as a profile that can be changed by the user. Instead of providing the profile so that it can be changed by the user, the processing may be performed based on a static profile stored by the data processing apparatus 101.

Next, processing in step S1109 will be described. When the processing proceeds from step S1107 to step S1109, the data processing apparatus 101 determines whether the memory required for generating a JPEG-based PDL at the resolution determined in step S1107 has been successfully secured. On the other hand, if it is determined in step S1105 that the memory equal to or greater than a specific threshold value remains, the processing in step S1109 is similar to step S707. In this step, if the memory has been successfully allocated (YES in step S1109), the processing proceeds to step S1110. On the other hand, if the memory has failed to be allocated (NO in step S1109), the processing proceeds to step S1108. Examples of failure to allocate the memory include a case in which although there was free memory at step S1105 or S1107, the memory is not free when actually allocating the memory in step S1109.

In step S1108, similarly to step S708, a toner array-based PDL is generated, and the generated PDL is transmitted as print data to the print processing apparatus 104.

In step S1110, similarly to step S710, a JPEG-based PDL is generated. However, if the processing has proceeded via step S1107, then a JPEG-based PDL is generated according to the resolution determined in step S1107. Then, the PDL is transmitted as print data to the print processing apparatus 104.

Through the above processing, when generating a JPEG-based PDL, the resolution of the JPEG to be generated is determined according to the currently available remaining memory capacity. Therefore, compared with the first exemplary embodiment, there are more opportunities for selecting a JPEG-based PDL. According to the second exemplary embodiment, although the printing quality is reduced, the number of opportunities in which high-speed processing is performed can be increased.

Other exemplary embodiments will now be described.

Exemplary embodiments of the present invention can also be realized by executing the following processing.

Software (a program) for realizing the functions of the above exemplary embodiments is supplied to a system or an apparatus via a network or various storage media, and a computer (or a CPU or a micro processing unit (MPU)) of the system or the apparatus reads and executes the program.

According to the exemplary embodiments of the present invention, printing according to a printing environment including a memory status can be realized by giving consideration to whether a print processing apparatus supports processing of second print data and whether memory for generating the second print data has been successfully allocated.

Embodiments can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

while the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-222523 filed Oct. 25, 2013, which is hereby incorporated by reference herein in its entirety.

What is claimed is:

1. An information processing apparatus comprising:
a generation unit configured to generate first print data by dividing image data into units of bands or second print data without dividing image data into units of bands; and
a determination unit configured to determine whether memory of the information processing apparatus for generating the second print data has been successfully allocated,
wherein the generation unit is configured to generate the second print data if the determination unit determines that the memory of the information processing apparatus for generating the second print data has been successfully allocated, and to generate the first print data if the determination unit determines that the memory of the information processing apparatus for generating the second print data has failed to be allocated.

2. The information processing apparatus according to claim 1, wherein the determination unit is further configured to determine whether a print processing apparatus supports processing of the second print data, and
wherein the generation unit is configured to generate the first print data if the determination unit determines that the print processing apparatus does not support the processing of the second print data.

3. The information processing apparatus according to claim 2, wherein the determination unit is further configured to, if the determination unit determines that the print processing apparatus supports the processing of the second print data, determine whether a free memory capacity of the information processing apparatus is equal to or greater than a specific threshold value, and if the determination unit determines that the free memory capacity is equal to or greater than the specific threshold value, determine whether the memory of the information processing apparatus for generating the second print data has been successfully allocated.

4. The information processing apparatus according to claim 3, further comprising a setting unit configured to set a processing mode for attempting to allocate the memory for generating the second print data even if the free memory capacity is less than the specific threshold value,
wherein the memory is attempted to be allocated if the processing mode is set by the setting unit even if the determination unit determines that the free memory capacity is less than the specific threshold value.

5. The information processing apparatus according to claim 1, wherein the generation unit is configured to generate the first print data in units of bands by performing color conversion of an image and then performing halftone-processing on the color converted image, and to generate the second print data by rendering an entire page all at once.

6. The information processing apparatus according to claim 3, further comprising a setting unit configured to set a processing mode for attempting to allocate the memory for generating the second print data by reducing a resolution even if the free memory capacity is less than the specific threshold value,
wherein the memory is attempted to be allocated if the processing mode is set by the setting unit even if the determination unit determines that the free memory capacity is less than the specific threshold value.

7. A method for controlling an information processing apparatus, the method comprising:
generating first print data by dividing image data into units of bands or second print data without dividing image data into units of bands; and
determining whether memory of the information processing apparatus for generating the second print data has been successfully allocated,
wherein the second print data is generated if it is determined that the memory of the information processing apparatus for generating the second print data has been successfully allocated, and the first print data is generated if it is determined that the memory of the information processing apparatus for generating the second print data has failed to be allocated.

8. The method according to claim 7, wherein the determining step further determines whether a print processing apparatus supports processing of the second print data, and
wherein the first print data is generated if it is determined that the print processing apparatus does not support the processing of the second print data.

9. The method according to claim 8, wherein if it is determined that the print processing apparatus supports the processing of the second print data, the determining step further determines whether a free memory capacity of the information processing apparatus is equal to or greater than a specific threshold value, and if it is determined that the free memory capacity is equal to or greater than the specific threshold value, it is determined whether the memory of the information processing apparatus for generating the second print data has been successfully allocated.

10. The method according to claim 9, further comprising setting a processing mode for attempting to allocate the memory for generating the second print data even if the free memory capacity is less than the specific threshold value,
wherein the memory is attempted to be allocated if the processing mode is set in the setting step even if it is determined that the free memory capacity is less than the specific threshold value.

11. The method according to claim 7, wherein the first print data is generated in units of bands by performing color conversion of an image and then performing halftone-processing on the color converted image, and the second print data is generated by rendering an entire page all at once.

12. The method according to claim 9, further comprising
setting a processing mode for attempting to allocate the memory for generating the second print data by reducing a resolution even if the free memory capacity is less than the specific threshold value,
wherein the memory is attempted to be allocated if the processing mode is set in the setting step even if it is determined that the free memory capacity is less than the specific threshold value.

13. A non-transitory computer-readable storage medium storing a program that causes a computer to execute a method for controlling an information processing apparatus, the method comprising:
generating first print data by dividing image data into units of bands or second print data without dividing image data into units of band s; and
determining whether memory of the information processing apparatus for generating the second print data has been successfully allocated,
wherein the second print data is generated if it is determined that the memory of the information processing apparatus for generating the second print data has been successfully allocated, and the first print data is generated if it is determined that the memory of the information processing apparatus for generating the second print data has failed to be allocated.

14. The non-transitory computer-readable storage medium according to claim 13, wherein the determining step further determines whether a print processing apparatus supports processing of the second print data, and
wherein the first print data is generated if it is determined that the print processing apparatus does not support the processing of the second print data.

15. The non-transitory computer-readable storage medium according to claim 14, wherein if it is determined that the print processing apparatus supports the processing of the second print data, the determining step further determines whether a free memory capacity of the information processing apparatus is equal to or greater than a specific threshold value, and if it is determined that the free memory capacity is equal to or greater than the specific threshold value, it is determined whether the memory of the information processing apparatus has been successfully allocated.

16. The non-transitory computer-readable storage medium according to claim 15, wherein the method further comprises setting a processing mode for attempting to allocate the memory for generating the second print data even if the free memory capacity is less than the specific threshold value,
wherein the memory is attempted to be allocated if the processing mode is set in the setting step even if it is determined that the free memory capacity is less than the specific threshold value.

17. The non-transitory computer-readable storage medium according to claim 13, wherein the first print data is generated in units of bands by performing color conversion of an image and then performing halftone-processing on the color converted image, and the second print data is generated by rendering an entire page all at once.

18. The non-transitory computer-readable storage medium according to claim 15, wherein the method further comprises setting a processing mode for attempting to allocate the memory for generating the second print data by reducing a resolution even if the free memory capacity is less than the specific threshold value,
wherein the memory is attempted to be allocated if the processing mode is set in the setting step even if it is determined that the free memory capacity is less than the specific threshold value.
